(19) United States
(12) Patent Application Publication
(10) Pub. No.: US 2018/0060077 A1
(43) Pub. Date: Mar. 1, 2018

(54) TRUSTED PLATFORM MODULE SUPPORT ON REDUCED INSTRUCTION SET COMPUTING ARCHITECTURES

(71) Applicant: QUALCOMM Incorporated, San Diego, CA (US)

(72) Inventors: Harb Abdulhamid, Durham, NC (US); Darren Lasko, Forest, VA (US)

(21) Appl. No.: 15/249,292

(22) Filed: Aug. 26, 2016

(51) Int. Cl. G06F 9/44

(52) U.S. Cl. CPC G06F 9/4401; H04L 2209/127

(57) ABSTRACT

Exemplary features pertain to providing trusted platform module (TPM) support for ARM®-based systems or other Reduced Instruction Set Computing (RISC) systems. In some examples, secure firmware (e.g., TrustZone firmware) operates as a shim between an unsecure high level operating system (HLOS) and a discrete TPM chip or other trusted execution environment component. The secure firmware reserves a portion of non-secure memory for use as a command response buffer (CRB) control block accessible by the HLOS. The secure firmware translates and relays TPM commands/responses between the HLOS and the TPM via the non-secure CRB memory. The system may also include various non-secure firmware components such as Advanced Configuration and Power Interface (ACPI) and Unified Extensible Firmware Interface (UEFI) components. Among other features, the exemplary system can expose the TPM to the HLOS via otherwise standard UEFI protocols and ACPI tables in a manner that is agnostic to the HLOS.

### BACKGROUND

### Field of the Disclosure

Various features relate generally to security protocols and devices, and more particularly to methods and apparatus for supporting trusted platform modules (TPM) on reduced instruction set computing (RISC) architectures such as ARM® architectures.

### Description of Related Art

Trusted platform module (TPM) is an international standard for a secure cryptoprocessor, which may be a dedicated microcontroller designed to secure hardware by integrating cryptographic keys into devices. The TPM technical specifications are provided by the Trusted Computing Group (TCG), which is a computer industry consortium. As a dedicated microprocessor, the TPM hardware may be separate from the central processor unit (CPU) of a device. A TPM may be responsible for performing various secure functions such as key generation and certificate storage, measured boot (i.e., platform integrity checking), remote attestation, binding, sealing, disk encryption, password protection, etc., and may serve as a root of trust for the operation of the device. For example, TPM facilities the secure generation of cryptographic keys and provides limitations on their use. For remote attestation, TPM creates a substantially unforgeable hash summary of the hardware and software configuration to allow third parties to verify that the configuration has not been changed. For binding, TPM encrypts data using a TPM bind key and a unique Rivest-Shamir-Adleman (RSA) key. For sealing, TPM encrypts data in a manner similar to binding while also specifying a state in which the TPM must be in order for the data to be decrypted (i.e. unsealed). Software can use the TPM to authenticate hardware devices. Each TPM chip has a unique and secret RSA key burned in as it is produced and hence is capable of performing platform authentication. TPM chips may communicate with a CPU through a serial peripheral interface (SPI) bus.

A solution for supporting TPMs on ARM®-based systems and servers is needed since TPMs are in large part currently designed for Intel®-based systems. For example, on Intel® systems, the CPU accesses a TPM command response buffer (CRB) directly over addressable SPI memory-mapped input/output (MMIO). This is not typically possible on ARM®-based systems because there is no equivalent MMIO support.

Further issues may arise when attempting to support TPM in a server platform (as opposed to, e.g., a mobile device platform) if using ARM®-based processors. In this regard, TPM is often a requirement for server customers but the software delivery model for servers is different from mobile devices. Servers typically only deliver standardized boot and run-time firmware interfaces (i.e. Unified Extensible Firmware Interface (UEFI)/Advanced Configuration and Power Interface (ACPI)). The customer is free to run any UEFI/ACPI compliant high level operating system (HLOS) such as Windows™, Redhat™, VMWare™, etc. Moreover, although a firmware-based TPM can be appropriate for some mobile platforms, firmware TPM may not be suitable within server platforms for several reasons. For example, obtaining necessary security certifications on an internal firmware TPM can be costly for the vendor; whereas discrete TPMs often already have the certifications in place. Furthermore, whenever changes are made to secure firmware (e.g. ARM® TrustZone firmware), recertification is typically required.

Accordingly, a solution for supporting TPMs on ARM®-based systems or other non-Intel®-based processors should address these and other issues. Still further, such a solution should be OS agnostic and capable of protecting/supporting multiple TPM localities (where a locality refers, e.g., to particular portions or registers of memory accessible by software or other computing components based on privilege levels).

### SUMMARY

In one aspect, a method for use in a computing system having a processor equipped to run an operating system (OS) and having a trusted execution environment includes: designating a portion of a memory space accessible by the OS as a command response buffer (CRB) for use with the trusted execution environment; and relaying messages between the processor and the trusted execution environment using the CRB of the memory space.

In another aspect, a device includes: a processor configured to designate a portion of a memory space accessible by an OS as a CRB; and relay messages between the processor and a trusted execution environment using the CRB of the memory space.

In yet another aspect, a device for use in a computing system having a processor equipped to run an OS and having a trusted execution environment, comprising: means for designating a portion of a memory space accessible by the OS as a CRB for use with the trusted execution environment; and means for relaying messages between the processor and the trusted execution environment using the firmware and the CRB of the memory space.

In still yet another aspect, a non-transitory machine-readable storage medium is provided for use with a computing system equipped to run an OS and having a trusted execution environment, the machine-readable storage medium having one or more instructions which when executed by at least one processing circuit of the computing system causes the at least one processing circuit to: designate a portion of a memory space accessible by the OS as a command response buffer (CRB) for use with the trusted execution environment; and relay messages between the processor and the trusted execution environment using the CRB of the memory space.

### BRIEF DESCRIPTION OF THE DRAWINGS

FIG. 1 is a high-level schematic block diagram illustrating selected components of a computing system provided with secure firmware equipped to control CRB functions and relay commands/responses between an HLOS and a discrete TPM chip or other trusted execution environment component.

FIG. 2 is a process flow diagram of further illustrating selected operations performed by the various components of the computing system of FIG. 1 to control CRB and relay commands/responses between the HLOS and the discrete TPM chip.

FIG. 3 is a timing diagram illustrating selected operations performed by the various components of the computing system of FIG. 1 to control CRB and relay commands/responses between the HLOS and the discrete TPM chip.

FIG. 4 is a schematic block diagram illustrating an exemplary computing system equipped with an ARM®-based CPU and Secure CRB firmware configured to relay commands/responses between the HLOS and the discrete TPM chip.

FIG. 5 is a block diagram illustrating an example of a hardware implementation for an apparatus employing a processing system that may exploit the systems, methods and apparatus of FIGS. 1-4.

FIG. 6 is a block diagram illustrating exemplary components of a computing and/or processing system equipped with components configured to control CRB functions and relay commands/responses between an HLOS and a discrete TPM chip of the system.

FIG. 7 summarizes exemplary procedures for use by firmware to relay commands/responses between an HLOS and a discrete TPM chip.

FIG. 8 further illustrates exemplary procedures for use by firmware to relay commands/responses between an HLOS and a discrete TPM chip.

FIG. 9 is a block diagram illustrating exemplary components pertaining to slave-side protection of a discrete TPM chip.

FIG. 10 is a schematic diagram illustrating exemplary components pertaining to locality protection when using a discrete TPM chip.

FIG. 11 summarizes exemplary procedures for use by an HLOS for providing Commands for a TPM chip and for processing Responses received from the TPM chip, with the Commands and Response relayed via Secure CRB Firmware.

FIG. 12 summarizes exemplary procedures for use by a TPM chip for receiving commands for an HLOS and for generating Responses thereto, with the Commands and Response relayed via Secure CRB Firmware.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### TPM Support for RISC-Based Computing Systems

Several novel features pertain to devices and methods for use with computing devices such as wireless communication devices, servers, or the like. Some features described herein relate to providing trusted platform module (TPM) support on ARM®-based systems (or other RISC processor systems) or for providing support for other trusted execution environment devices or components. In some examples, features are provided that leverage and exploit secure firmware (e.g., TrustZone firmware) to act as a shim between an unsecure high level operating system (HLOS) running on a hardware device such as a System-on-a-Chip (SoC), and a separate and discrete TPM chip.

Although described primarily in connection with examples wherein the processor is ARM® processor, various features described herein may be exploited within other non-Intel®-based systems and, in particular, within computing systems that do not allow a CPU to access a TPM CRB directly over an addressable SPI MMIO. Furthermore, although described primarily in connection with examples wherein the trusted execution environment component is a TPM chip, various features described herein may be exploited for use with other trusted execution environment components or devices, such as other components equipped to secure hardware by integrating cryptographic keys, including devices equipped to perform secure functions such as one or more of key generation and certificate storage, measured boot, remote attestation, binding, sealing, disk encryption, password protection, etc., and which may serve as a root of trust for the operation of the device.

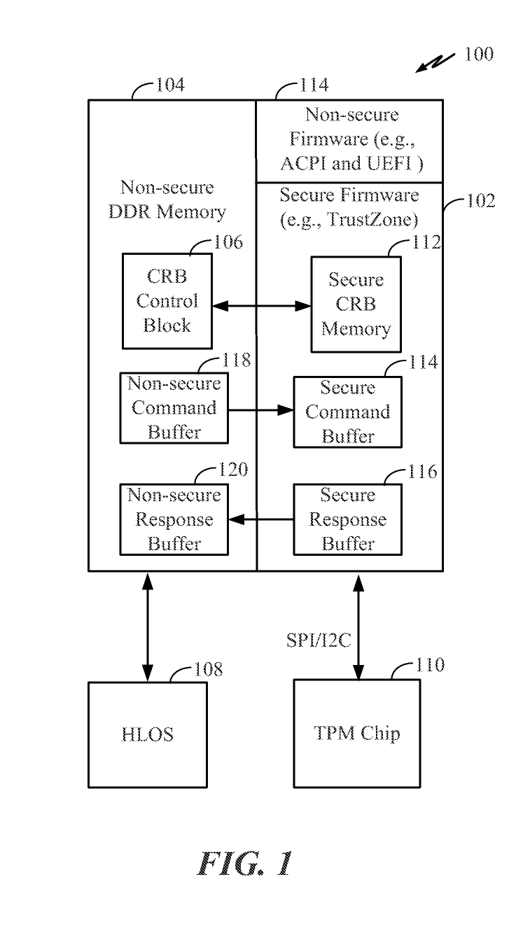

FIG. 1 illustrates selected features of an exemplary computing system 100 wherein a portion of secure firmware 102 is configured to reserve (or otherwise designate) a region of non-secure double data rate (DDR) memory 104 for use as a Command Response Buffer (CRB) Control Block 106 into which a high level operating system (HLOS) 108 can write commands intended for a TPM chip 110 (or other trusted execution environment component) via the command buffer 118 and also read TPM responses via the response buffer 120. The secure firmware 102 copies TPM commands that have been written by the HLOS to the unsecure CRB Control Block 106 into a secure CRB memory 112 along with copying non-secure command buffer 114 and also translates the commands using the appropriate TPM interface protocol (e.g., SPI, I2C, etc.) to thereby communicate with the TPM chip 110. (I2C may also be referred to as I²C). Similarly, the secure firmware 102 receives responses to the commands from the TPM chip 110, translates the responses from the TPM interface protocol back to a protocol used by the HLOS 108, and then writes the translated secure response buffer 116 to unsecure response buffer 120 and updating the CRB Control Block 106 for the HLOS 108 to retrieve.

Thus, the control block is a component of the CRB. In the examples described herein, the CRB has three components: 1) Control block; 2) Command buffer (address and size specified in control block per TCG spec); and 3) Response buffer (address and size specified in control block per TCG spec) When writing commands, a portion is written to the control block but the actual command is written to the command buffer. When reading responses, a portion is written to the control block, but the actual response is written to the response buffer. Note also that both secure firmware and secure CRB memory could reside in a protected region of DDR or in on-chip RAM, so long as it is protected by some form of hardware based access control (e.g. an XPU, discussed below).

In this manner, even though a discrete (i.e. off-package) TPM chip is used, the HLOS is notified there is a TPM that supports the CRB interface at certain addresses within the regular DDR address space of the system. This serves to abstract away the details of the hardware interface and to enforce localities. Status flags may be used by the HLOS 108 and the secure firmware 102 to indicate when a command has been written to the CRB Control Block 106 and non-secure command buffer 118 is ready to be transmitted to the TPM chip 110 and vice versa for responses. Additionally or alternately, suitable interrupts may be generated. Slave-side protection of the TPM (along with related resources and peripherals) may be provided as well, as discussed below. Note that the HLOS may include or comprise a hypervisor, i.e. a virtual machine manager.

Within ARM®-based systems, the secure firmware may be secured at an EL3 level (e.g. the highest privileged TrustZone level). In addition to the secure firmware 102, the system may include various non-secure firmware components 114 such as Advanced Configuration and Power Interface (ACPI) and Unified Extensible Firmware Interface (UEFI) components. Still further, the non-secure firmware may accommodate the ACPI Start Method and utilize the trusted execution environment (TrEE) EFI Protocols. Note that an alternative to UEFI boot firmware is a UBOOT. An alternative to ACPI firmware tables are Device Tree (DT) based firmware tables (as leveraged, e.g., on Android systems). Other types of “non-secure firmware tables” may be used to abstract CRB details.

Among other features, the computing system of FIG. 1 can expose the TPM CRB interface to the HLOS via otherwise standard UEFI protocols and ACPI tables in a manner that is agnostic to the HLOS. After the HLOS writes a CRB control buffer command to a reserved DDR location, the HLOS can invoke the otherwise standard “TPM start method” per the TPM protocol. For an ARM®-based system, the start method may be in the form of a standard Secure Monitor Call (SMC) call per the ARM® SMC Calling Convention (SMCCC) specification. Secure firmware retrieves the contents of the CRB control block from the reserved portion of DDR and packages the contents to the appropriate TPM interface protocol that has been invoked (e.g. SPI, I2C or firmware-based TPM). Thus, the exemplary system serves to configure the CRB control buffer using secure firmware and to translate CRB commands to multiple protocols using that secure firmware. For a discrete TPM chip, this may involve SPI or I2C protocol. For a firmware TPM, an internal vendor specific implementation of the firmware TPM may involve on-chip hardware. Still further, the exemplary system serves to protect TPM localities by hiding direct hardware access behind ARM® secure firmware (aka TrustZone). Notably, this secure firmware-based approach permits usage of non-standard SPI and I2C controllers without HW or HLOS modifications.

As such, the exemplary computing system provides a TPM solution for use with non-Intel®-based systems that 1) abstracts hardware details via ACPI (or similar protocols and firmware tables) to provide an OS agnostic solution and 2) protects and supports multiple localities by moving any direct hardware interaction into secure firmware. For an ARM®-based system, these goals are achieved, at least in part, by leveraging the TCG ACPI and CRB specifications. As noted above, on Intel®-based systems, the OS can access the CRB on the TPM chip directly over addressable SPI (MMIO) off the Intel Southbridge. This is not typically possible on ARM®-based systems because there is no equivalent MMIO support. As part of the solution, the intermediate CRB buffer reserved within DDR memory may be managed by secure (EL3) firmware and exposed by ACPI. In some examples, the secure firmware copies CRB contents from DDR over the SPI bus on a call to the ACPI TPM start method. The TPM start method then invokes an SMC directly or via ACPI Machine Language (AML) as specified by the TCG ACPI table. These features will be described in further detail below.

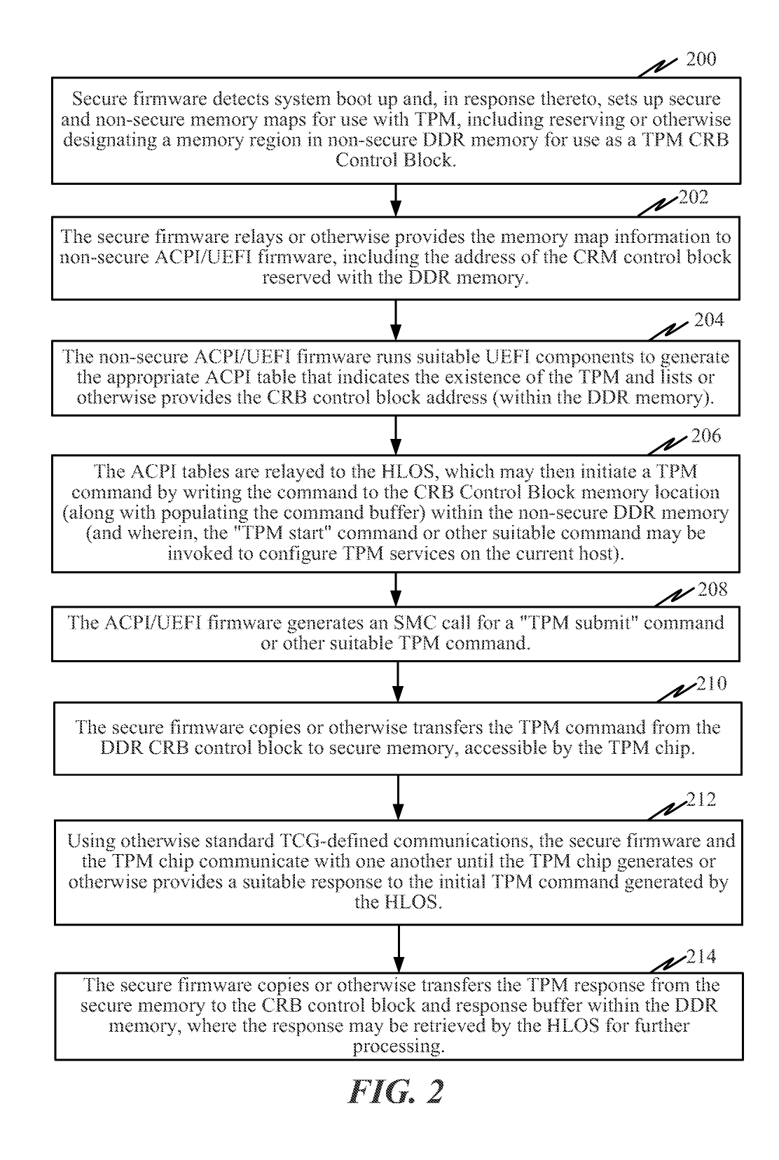

FIG. 2 summarizes an exemplary process that may be implemented using the system of FIG. 1 or other suitably-equipped systems. At 200, secure firmware detects boot up and, in response thereto, sets secure and non-secure memory maps for use with TPM, including reserving or designating a memory region in a non-secure DDR memory for use as the CRB Control Block. At 202, the secure firmware relays or otherwise provides the memory map information to non-secure ACPI/UEFI firmware, including providing the address of the CRM control block with the DDR. Note that this information may be provided via other firmware protocols (e.g. U-BOOT, Device Tree). At 204, the non-secure ACPI/UEFI firmware runs suitable UEFI components to generate the appropriate ACPI table that indicates the existence of the TPM and provides the CRB control block address within the DDR memory. At 206, the ACPI tables are relayed to the HLOS, which may then initiate a TPM command by writing the command to the CRB Control Block memory location (along with populating the command buffer) within the non-secure DDR memory. The “TPM start” method or other suitable method may be invoked to configure TPM services on the current host. At 208, the ACPI/UEFI firmware invokes an SMC call for a “TPM submit” command or other suitable command (The TPM Submit command is a non-standard SMC function discussed in detail below). The SMC may be invoked directly by the HLOS as part of the “TPM start” method (as specified by the TCG ACPI table). At 210, the secure firmware copies or otherwise transfers the TPM command from the DDR CRB control block to secure memory, which can be accessed by the TPM chip. At 212, using otherwise standard TCG-defined communications, the secure firmware and the TPM chip communicate with one another until the TPM chip generates or otherwise provides a suitable response to the initial TPM command generated by the HLOS. At 214, the secure firmware copies or otherwise transfers the TPM response from the secure memory to the CRB control block and response buffer within the DDR memory, where it may be retrieved by the HLOS for further processing.

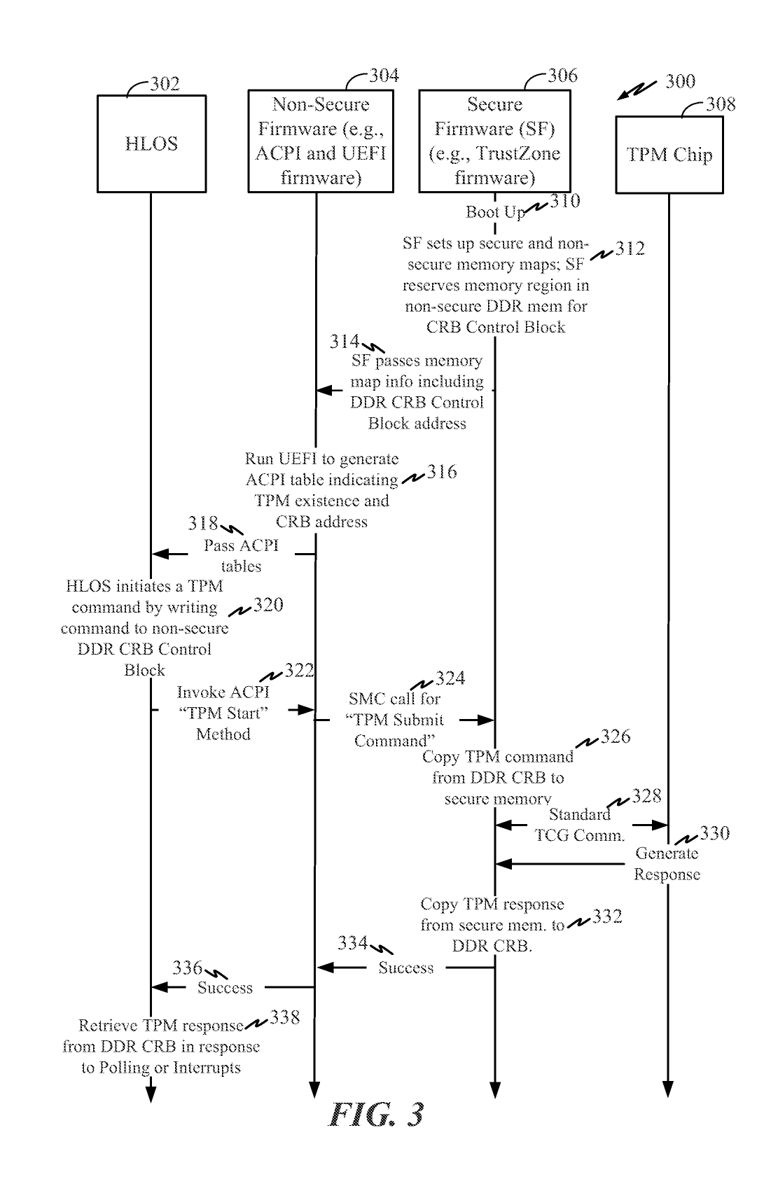

FIG. 3 is a timing diagram 300 further illustrating these procedures. In particular, FIG. 3 illustrates the operations of HLOS 302, non-secure firmware 304, secure firmware 306 and a discrete TPM chip 308. In this example, communication between the non-secure firmware and the secure firmware is through standardized ARM® SMC calls, and communication between the secure firmware and the TPM is via SPI or I2C per TCG protocols. When the system initially boots up, at 310, exception level 3 (EL3) code is executed by the secure firmware 306. This causes the secure firmware to map various secure memory regions and unsecure memory regions, at 312. The secure firmware also reserves a portion of the unsecure DDR memory as the CRB Control Block and, at 314, passes the memory map information to the non-secure firmware, including the DDR CRB control block address so as to provide one or more memory maps. At 314, the UEFI is started, if not already running.

Once memory maps are generated, the overall system moves to EL2 where, at 316, the unsecure firmware (e.g., UEFI BIOS) runs and the memory map information is retrieved via ACPI from secure firmware along with the CRB Control Block memory address. The unsecure firmware also generates ACPI tables that designate the existence of, and provide profiles for, many of the peripheral hardware components of the system, including the existence of a TPM having a CRB with a memory address within the unsecure DDR memory. The ACPI tables are passed to the HLOS, at 318. The HLOS may then decide to initiate, at 320, a TPM command. To do so the HLOS writes its TPM command to the CRB Control Block (specifically its command buffer) and sets the command-ready bit high to indicate that a TPM command is there and waiting to be retrieved. This may involve setting cmdReady and Start bits. Next, at 322, a “TPM Start” method is invoked which may cause the unsecure firmware (e.g., ACPI firmware) to perform an SMC call “TPM Submit Command”, at 324, which causes the secure firmware to copy the TPM command found in the unsecure CRB Control Block (along with the associated command buffer) over to secure memory, at 326. The TPM Submit Command is discussed in greater detail below. (Note that this particular “command” is intended for the secure firmware and is not necessarily a “true” TPM command. Rather, it is an SMC function call.)

Next, at 328, standard secure firmware-to-TPM commands are executed until a response is generated by the TPM, at 330. This may involve waking up the TPM via SPI and sending the command to a TPM FIFO buffer so that the TPM may input and process the command and generate its response. (Although not shown, various success signals may be relayed to the HLOS before a final response is generated to notify the HLOS that the command was successfully received by the TPM.) Once a response is generated, the secure firmware, at 332, copies the response to the CRB Control Block (specifically its response buffer) for the HLOS to retrieve. As shown, various success signals, 334 and 336, may be relayed, to inform the HLOS that a response was generated by the TPM. At 338, the HLOS retrieves the TPM response from DDR CRB in response to Polling or Interrupts or other success signals that notify the HLOS that a response is ready. In this regard, suitable flags (e.g. command-ready bit) may be set for periodic polling or one or more interrupts may be generated by firmware or hardware. Notably, regardless of the specific interface (e.g., SPI, I2C, proprietary protocol, etc.) between the secure firmware 306 and the TPM 308, the manner of communication between the HLOS 302 and the secure firmware 306 is the same. Moreover, TPM localities are protected from direct hardware access because they are hidden behind the secure firmware. For ARM®-based systems, non-Secure World privileges may be restricted to only access locality 0.

Note that implementing the foregoing features may involve modifications to current TCG specifications. For example, the TCG ACPI table specification may be updated to make minor changes to enable implementation of CRB for ARM® Server systems. Suitable changes may include: creating a new revision of the TPM2 table that adds a new Type to appropriate sections in the TCG ACPI specification (e.g. TCG ACPI Specification for Family 1.2 and 2.0, Level 00, Revision 00.37). In particular, a new Type 11 may be defined where Type 11=“Uses the Command Response Buffer Interface with ARM SMC Call.” If interrupts are used, then the interrupt details may be added to the appropriate TCG specifications. For example, in place of the “Platform Specific Parameters” defined in the TCG specifications, fields may be added to describe a TPM interrupt. For longer commands, the HLOS may be instructed to wait on the interrupt instead of polling the control area to wait on the response. In that example, firmware/hardware will raise an interrupt once the response buffer is ready for consumption. As noted, a new ARM SMC calling convention extension may be used that employs the aforementioned function ID called “TPM submit command ” Table 1 lists exemplary parameters for the new TPM submit command.

TABLE I

| Parameters | Value |
|---|---|
| Unit32 function ID | 0x8200 1700 SMC32 |
| | 0xC200 1700 SMC64 |
| RETURN | SUCCESS |
| | NOT_SUPPORTED |
| | INVALID_PARAMETER |
| | NO_MEMORY |
| | DENIED |
| | See [SMCCC] for error code |
| | values |

As can be appreciated by those skilled in the art, these and other details may vary depending upon the implementation and a revised TCG specification may differ.

### Exemplary System-on-a-Chip Hardware Environment

Aspects of the systems and methods described herein can be exploited using a wide variety of computing devices and for a wide range of applications, including mobile devices and servers. To provide a concrete example, an exemplary hardware environment will now be described that uses an ARM® CPU.

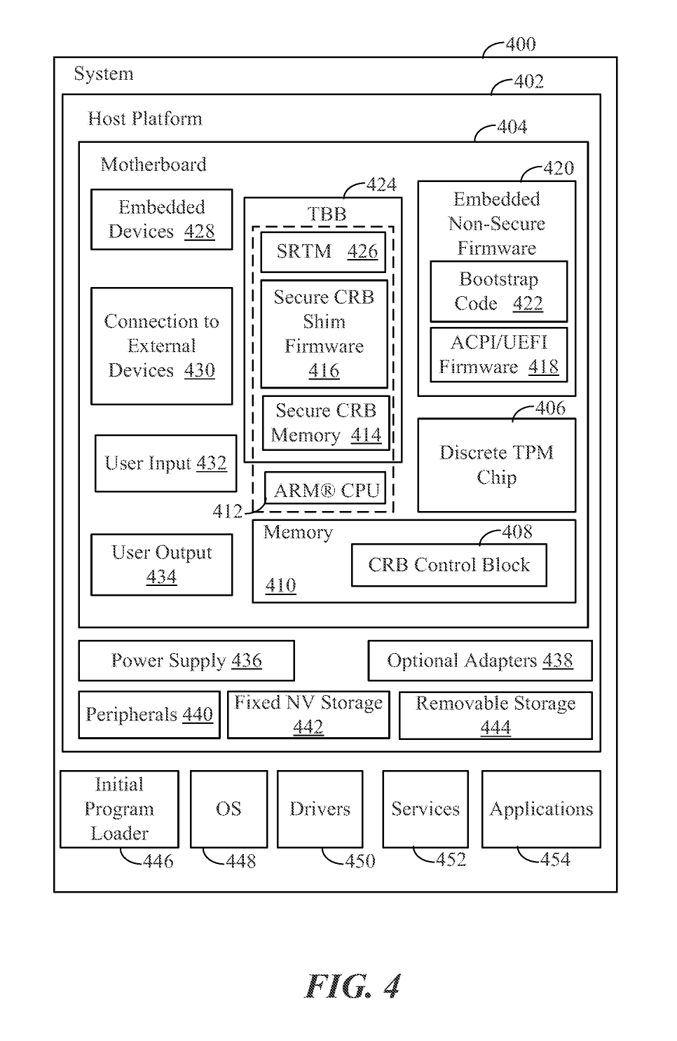

FIG. 4 illustrates selected components of a PC client specific architecture modified to incorporate secure CRB firmware configured to translate HLOS commands to TPM commands and vice versa using secure CRB memory and a portion of reserved non-secure memory for use as a CRB control block. Within the figure, a system 400 includes a host platform 402, which includes a motherboard 404. In this example, the TPM 406 is a discrete chip on the motherboard 404. A CRB control block 408 is reserved within non-secure memory 408, also provided on the motherboard. Using procedures described above, TPM commands generated by an HLOS running on a secure ARM® CPU 412 are initially stored within CRB control block 408 of DDR memory 410. The secure firmware 416 copies the commands into a secure CRB memory 414, then translates the commands into a protocol appropriate to the TPM chip 406 in coordination with ACPI/UEFI firmware 418. The ACPI/UEFI firmware 418 may be a portion of embedded non-secure firmware 420 also provided on the motherboard 404, which may include other firmware such as bootstrap code 422. In some examples, TPM 406 provides protected capabilities for the Host Platform 402 as defined by the TPM Library Specification of the TCG PC Client Platform Firmware Profile Specification, Family 2.0, Level 00, Revision 00.21, published Mar. 30, 2016 by the TCG or other suitable specifications.

Note that the secure CRB memory 414 and the secure CRB shim firmware 416 are components of the Trusted Building Block (TBB) 424, which also includes hardware and/or software that establishes a root trust (i.e. provides an integrity measurement) and provides connectivity between a Static Root of Trust for Measurement (SRTM) 426, the TPM 406, the motherboard 404, platform reset components (not separately shown), and a TPM physical presence signal (also not separately shown). An indication of physical presence of the TPM is provided within the TBB via the secure CRB firmware 416. Note also that the ARM® CPU may be implemented as a System-on-a-Chip (SoC).

Various other components and features of the ARM®-based system 400 are shown in FIG. 4. Briefly, in this example, the motherboard 404 additionally includes various other embedded devices 428, connections 430 to external devices, and user input 432 and user output 434 components. The host platform includes a power supply 436, optional adapters 438, peripherals 440, fixed nonvolatile storage 442 and removable storage 444. The overall system 400 further includes an initial program loader 446, the OS 448 (which typically runs on the ARM® CPU 412), various drivers 450, various services 452 and various applications 454 (where the drivers, services and applications may run on the ARM® CPU 412 on other processing components of the overall systems).

Further information regarding the components shown in FIG. 4 may be found within the aforementioned specification document (PC Client Platform Firmware Profile Specification, Family 2.0, Level 00, Revision 00.21, published Mar. 30, 2016) or other suitable documents, such as revision 20v43 of that specification. See, also, the TCG ACPI Specification, Version 1.00—FINAL, Revision 1.00, dated Aug. 8, 2005 or other suitable documents such as revision 1-10_0-37 of that specification. See, also, TCG Specification TPM 2.0 Mobile Command Response Buffer Interface, Family “2.0”, Level 00 Revision 12, dated 16 Dec. 2014 or other suitable documents such as revision v2r9-1 of that same specification. Those skilled in the art will recognize that modifications may need to be made, where appropriate, to some of these components to accommodate the modifications described herein that exploit the secure TPM interface firmware 416, the secure CRB 414 and the CRB control block 408 reserved within memory 410.

### Exemplary Systems and Methods

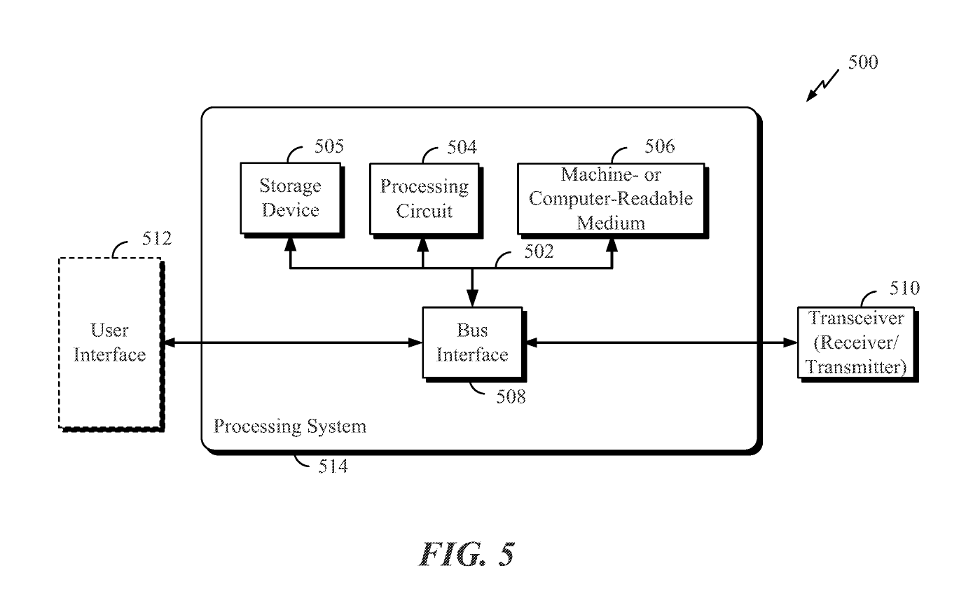

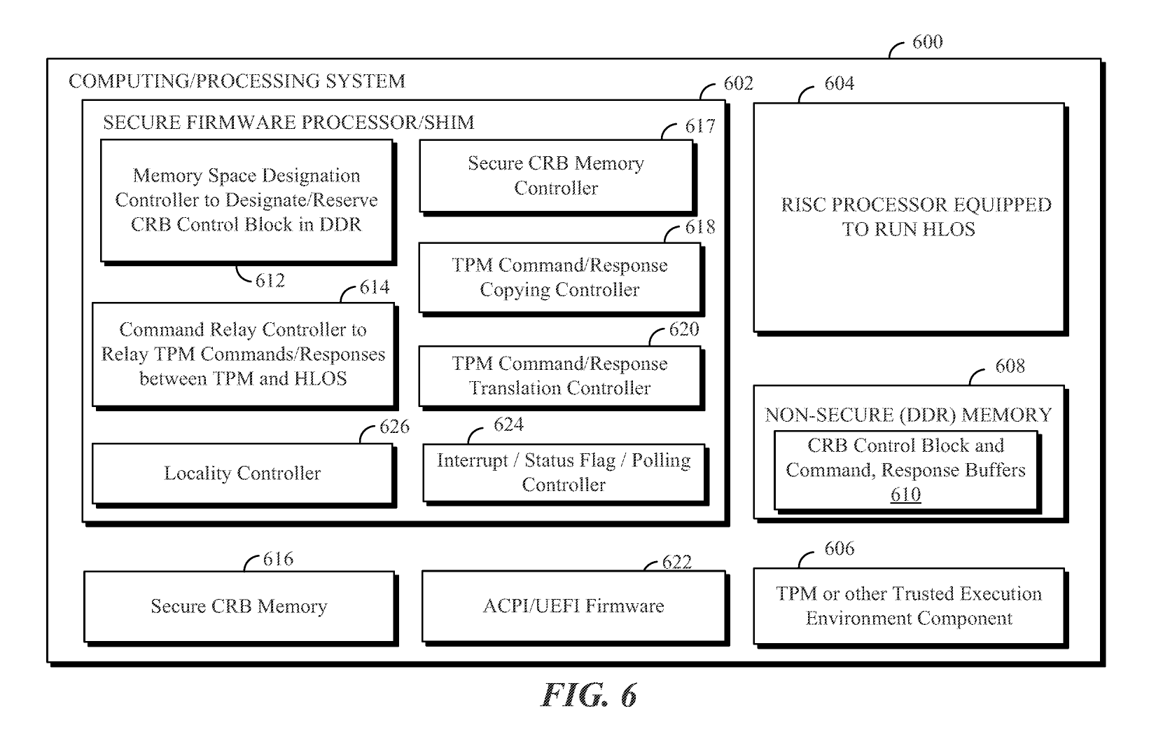

FIG. 5 illustrates an overall system or apparatus 500 in which the systems, methods and apparatus of FIGS. 1-4 may be implemented. In accordance with various aspects of the disclosure, an element, or any portion of an element, or any combination of elements may be implemented with a processing system 514 that includes one or more processing circuits 504 such as a SoC incorporating the ARM® CPU processing circuit of FIG. 4. For example, apparatus 500 may be a user equipment (UE) of a mobile communication system or a server platform. If a UE, apparatus 500 may be used with a radio network controller (RNC). In addition to an SoC, examples of processing circuits 504 that might be configured to implement processing features described herein include microprocessing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionality described throughout this disclosure. That is, the processing circuit 504, as utilized in the apparatus 500, may be used to implement aspects of any one or more of the processes described above and illustrated in FIGS. 1, 2, 3, and 4 (and those illustrated in FIGS. 6, 7, 8, 9, 10, 11 and 12, discussed below).

In the example of FIG. 5, the processing system 514 may be implemented with a bus architecture, represented generally by bus 502. The bus 502 may include any number of interconnecting buses and bridges depending on the specific application of the processing system 514 and the overall design constraints. The bus 502 links various circuits including one or more processing circuits (represented generally by the processing circuit 504), the storage device 505, and a machine-readable, processor-readable, processing circuit-readable or computer-readable media (represented generally by a non-transitory machine-readable medium 506) The bus 502 may also link various other circuits such as timing sources, peripherals, voltage regulators, and power management circuits, which are well known in the art, and therefore, will not be described any further. The bus interface 508 provides an interface between bus 502 and a transceiver 510. The transceiver 510 provides a means for communicating with various other apparatus over a transmission medium. Depending upon the nature of the apparatus, a user interface 512 (e.g., keypad, display, speaker, microphone, joystick) may also be provided.

The processing circuit 504 is responsible for managing the bus 502 and for general processing, including the execution of software stored on the machine-readable medium 506. The software, when executed by processing circuit 504, causes processing system 514 to perform the various functions described herein for any particular apparatus. Machine-readable medium 506 may also be used for storing data that is manipulated by processing circuit 504 when executing software.

One or more processing circuits 504 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 506. The machine-readable medium 506 may be a non-transitory machine-readable medium or computer-readable medium. A non-transitory processing circuit-readable, machine-readable or computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 506 may reside in the processing system 514, external to the processing system 514, or distributed across multiple entities including the processing system 514. The machine-readable medium 506 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system. For example, the machine-readable storage medium 506 may have one or more instructions which when executed by a firmware processing circuit or component of the processing circuit 504 causes the firmware processing circuit to: designate a portion of a memory space accessible by the OS as a command response buffer (CRB) for use with the TPM; and relay messages between the processor and the TPM using the CRB of the memory space.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

The various illustrative logical blocks, modules, circuits, elements, and/or components described in connection with the examples disclosed herein may be implemented or performed with a general purpose processing circuit, a digital signal processing circuit (DSP), an application specific integrated circuit (ASIC), a field programmable gate array (FPGA) or other programmable logic component, discrete gate or transistor logic, discrete hardware components, or any combination thereof designed to perform the functions described herein. A general purpose processing circuit may be a microprocessing circuit, but in the alternative, the processing circuit may be any conventional processing circuit, controller, microcontroller, or state machine. A processing circuit may also be implemented as a combination of computing components, e.g., a combination of a DSP and a microprocessing circuit, a number of microprocessing circuits, one or more microprocessing circuits in conjunction with a DSP core, or any other such configuration.

Hence, in one aspect of the disclosure, processing circuit 504 illustrated in FIG. 5—or components thereof—may be a specialized processing circuit (e.g., an ASIC)) that is specifically designed and/or hard-wired to perform the algorithms, methods, and/or blocks described in FIGS. 1, 2, 3, and 4 (and/or FIGS. 6, 7, 8, 9, 10, 11 and 12, discussed below). Thus, such a specialized processing circuit (e.g., ASIC) may be one example of a means for executing the algorithms, methods, and/or blocks described in FIGS. 1, 2, 3, and 4 (and/or FIGS. 6, 7, 8, 9, 10, 11 and 12, discussed below). The machine-readable storage medium may store instructions that when executed by a specialized processing circuit (e.g., ASIC) causes the specialized processing circuit to perform the algorithms, methods, and/or blocks described herein.

FIG. 6 illustrates selected and exemplary components of a computing system such as a UE or server 600 having a secure firmware processing circuit 602 that operates in conjunction with a RISC processor 604 (equipped to run a HLOS) and a TPM 606, which may be a discrete TPM chip (or other trusted execution environment component). A non-secure (DDR) memory 608 provides memory space that includes the aforementioned CRB Control Block (along with command and response buffers) 610. The secure firmware processor 602, which may be a firmware shim or equivalent is configured to designate a portion of a memory space accessible by the HLOS as the non-secure CRB memory 610 for use with the TPM 606 and to relay messages between the RISC processor 604 and the TPM 606 using CRB of the memory space 610. To this end, the secure firmware includes various functional components including, in this example, a Memory Space Designation Controller 612 operative to designate/reserve the non-secure CRB memory 610 in DDR 608 and a Command Relay Controller 614 operative to Relay TPM Commands/Responses between TPM and HLOS using the non-secure CRB memory 610 and a secure portion of CRB memory 616 (under the control of a Secure CRB Memory Controller 617).

In this example, Command Relay Controller 614 operates in conjunction with the Secure CRB Memory 616, a TPM Command/Response Copying Controller 618 and a TPM Command/Response Translation Controller 620. The TPM Command/Response Copying Controller 618 operates to copy TPM commands written by the HLOS into the non-secure CRB memory 610 from the CRB control block into secure CRB memory 616. The TPM Command/Response Translation Controller 620 operates to translate the commands to conform to a particular TPM protocol associated with the TPM and provide access by the TPM to the translated commands Once the TPM 606 responds, the TPM Command/Response Translation Controller 620 operates to translate command responses received from the TPM within the secure CRB memory to conform to a particular protocol associated with the OS of the processor. The Command/Response Copying Controller 618 then operates to copy the translated responses into the non-secure CRB memory 610 of the non-secure memory 610 for access by the HLOS of the RISC processor 604.

At least some of these components operate in conjunction with an ACPI/UEFI firmware controller 622. Whenever commands or responses are written into the non-secure CRB memory 610, interrupts and/or status flags for use with polling may be generated under the control of an interrupt/status flag/polling controller 624. Note that, as discussed above, the localities of various components of the overall computing system (such as software components running on the RISC processor) may be controlled by the secure firmware. Within FIG. 6, a locality controller 626 is therefore illustrated as a component of the secure firmware. As explained above, TPM localities are protected from direct hardware access because they are hidden behind the secure firmware. For ARM®-based systems, non-secure world privileges may be restricted to only access locality 0. Accordingly, the locality controller 626 controller may be used to initiate the restriction to locality 0 or to other suitable and programmable locality values or levels.

The various components of FIG. 6 may be replaced with a suitable means for performing or controlling the corresponding operations. Hence, in at least some examples, means for computing are provided that include a RISC processing means for RISC processing and a TPM processing means for TPM processing. Means for storing non-secure information may be provided along with means for storing secure information such as secure CRB information. Means may be provided to designate a portion of a memory space accessible by an the HLOS as a CRB control block for use with a TPM and means may be provided to relay messages between the HLOS and the TPM using the CRB control block. Still further, a memory space designation means may be provided to designate/reserve a CRB Control Block in non-secure memory and command relay means may be provided to relay TPM commands/responses between a TPM and an HLOS using the CRB Control Block and a secure portion of CRB memory.

Still further, a TPM command/response copying means may be provided to copy TPM commands written by the HLOS into the non-secure CRB memory from the non-secure CRB memory into the secure CRB memory. Means may be provided to translate the commands to conform to a particular TPM protocol associated with the TPM and to provide access by the TPM to the translated commands Once the TPM responds, a means for translating operates to translate command responses received from the TPM within the secure CRB memory to conform to a particular protocol associated with the OS of the processor. The means for copying then operates to copy the translated responses into the CRB control block and response buffer of the non-secure memory for access by the HLOS of the RISC processor. Means for generating interrupts and/or status flags for use with polling may be provided. Means for controlling the localities of various components of the overall computing system (such as software components running on the RISC processor) may also be provided.

For implementations where a machine-readable storage medium is exploited or provided, the operations of the various components of FIG. 6 may be represented with a suitable instruction for performing or controlling the corresponding operations. For example, a non-transitory machine-readable storage medium maybe provided for use with a computing system equipped to run an OS and having a TPM, where the machine-readable storage medium has one or more instructions which when executed by at least one firmware processing circuit of the computing system causes the at least one firmware processing circuit to: designate a portion of a memory space accessible by the OS as a command response buffer (CRB) for use with the TPM; and relay messages between the processor and the TPM using the CRB of the memory space. Still further, in at least some examples, instructions for storing non-secure information may be provided along with instructions for storing secure information such as secure CRB information. Instructions may be provided to designate a portion of a memory space accessible by an the HLOS as a CRB control block for use with a TPM and instructions may be provided to relay messages between the HLOS and the TPM using the CRB control block. Still further, memory space designation instructions may be provided to designate/reserve a CRB Control Block in non-secure memory and command relay instructions may be provided to relay TPM commands/responses between a TPM and an HLOS using the CRB Control Block and a secure portion of CRB memory.

Still further, TPM command/response copying instructions may be provided to copy TPM commands written by the HLOS into the non-secure CRB memory from the non-secure CRB memory into the secure CRB memory. Instructions may be provided to translate the commands to conform to a particular TPM protocol associated with the TPM and to provide access by the TPM to the translated commands Instructions for translating may be provided to translate command responses received from the TPM within the secure CRB memory to conform to a particular protocol associated with the OS of the processor. Instructions for copying may be provided that operate to copy the translated responses into the CRB control block and response buffer of the non-secure memory for access by the HLOS of the RISC processor. Instructions for generating interrupts and/or status flags for use with polling may be provided. Instructions for controlling the localities of various components of the overall computing system (such as software components running on the RISC processor) may also be provided.

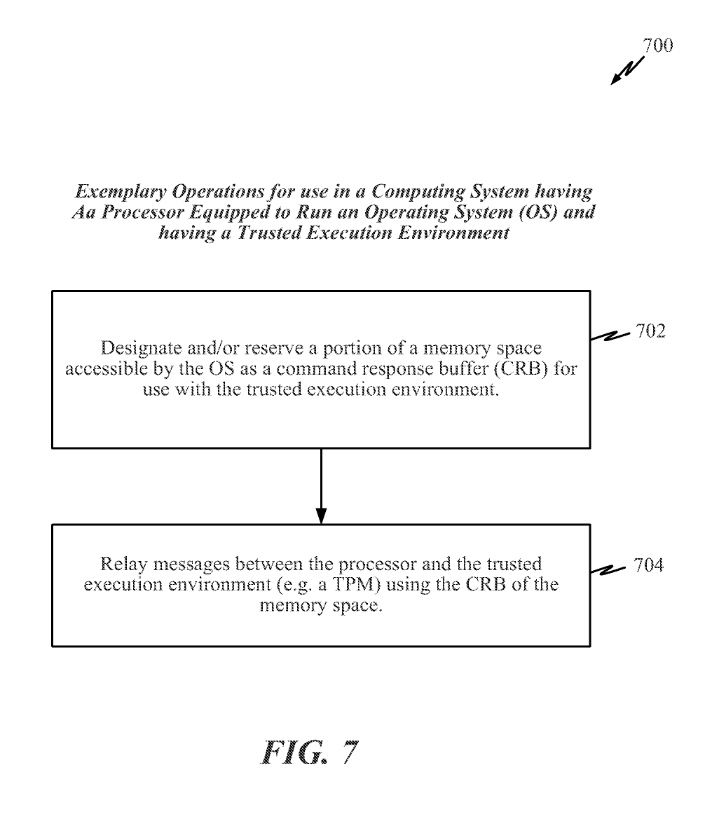

FIG. 7 broadly illustrates and summarizes methods or procedures 700 that may be performed by suitably equipped firmware devices or components. In particular, FIG. 7 illustrates exemplary operations for use in a computing system having a processor equipped to run an operating system (OS) and having a trusted execution environment. Briefly, at 702, a portion of a memory space accessible by the OS is designated and/or reserved as a command response buffer (CRB) for use with the trusted execution environment. At 704, messages are relayed between the processor and the trusted execution environment (e.g. a TPM) using the CRB of the memory space. As already explained, the processor may be an ARM®-based RISC processor, and a secure firmware shim may be provided to perform the functions of 702 and 704.

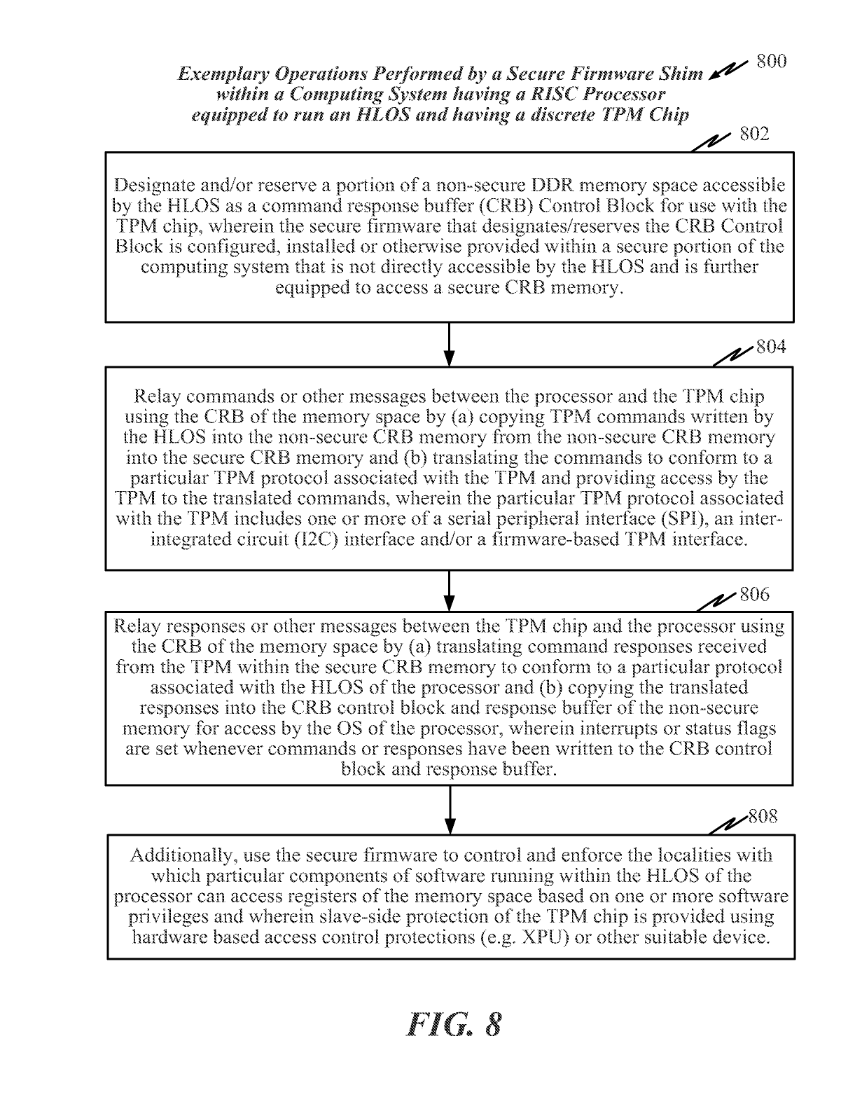

FIG. 8 further illustrates and summarizes methods or procedures 800 that may be performed by suitably equipped secure firmware shim devices or components in conjunction with a RISC processor running an HLOS and having a separate discrete TPM chip. At 802, the secure firmware designates and/or reserves a portion of a non-secure DDR memory space accessible by the HLOS as a CRB Control Block for use with the TPM chip, wherein the secure firmware that designates/reserves the CRB Control Block is configured, installed or otherwise provided within a secure portion of the computing system that is not directly accessible by the HLOS and is further equipped to access a secure CRB memory. At 804, the secure firmware relays commands or other messages between the processor and the TPM chip using the CRB of the memory space by (a) copying TPM commands written by the HLOS into the non-secure CRB memory from the non-secure CRB memory into the secure CRB memory and (b) translating the commands to conform to a particular TPM protocol associated with the TPM and providing access by the TPM to the translated commands, wherein the particular TPM protocol associated with the TPM includes one or more of SPI, I2C interface and/or a firmware-based TPM interface. At 806, the secure firmware relays responses or other messages between the TPM chip and the processor using the CRB of the memory space by (a) translating command responses received from the TPM within the secure CRB memory to conform to a particular protocol associated with the OS of the processor and (b) copying the translated responses into the non-secure CRB memory for access by the HLOS of the processor, wherein interrupts or status flags are set whenever commands or responses have been written to the CRB control block and response buffer.

At 808, the secure firmware is additionally used to control the localities with which particular components of software running within the HLOS of the processor can access registers of the memory space based on one or more software privileges and wherein slave-side protection of the TPM chip is provided, particularly when using SPI. In this regard, SPI enables the serial exchange of data between two devices, one called a master and the other called a slave. An SPI controller may be interposed between the TPM and a master. In some examples, an external protection unit (XPU) or other hardware based bus access controller may be used as the master to enhance the slave-side protection, such as a Qualcomm® XPU or a CoreLink™ Trustzone Address Space Controller, which may be an embedded memory, address, or register protection unit that guards against unauthorized access by enforcing access control to various peripherals, memory regions, etc. With XPU, even the HLOS can be blocked from accessing components if not authorized. The XPU serves to block access to the SPI controller (and all other secure peripherals associated with the TPM) by all non-authorized components and to block access to selected general purpose input/output (GPIO) units to provide the slave-side protection. Note that the XPU (or other hardware based bus access controller) may be equipped for use as an address protection unit (APU), register protection unit (RPU), or memory protection unit (MPU).

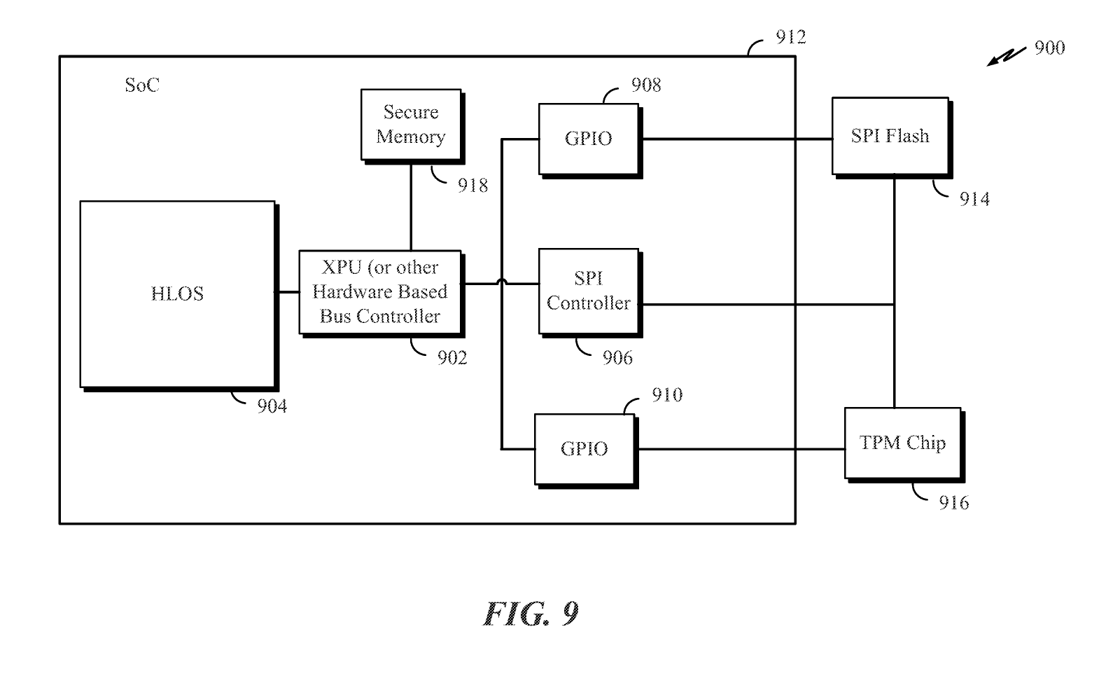

FIG. 9 illustrates further aspects of slave-side protection. Briefly, an XPU 902 (or other hardware based bus controller) of a computing system 900 is interposed between an HLOS 904, an SPI controller 906, Secure Memory 918, and a pair of GPIOs 908 and 910. These components may be formed on a SoC 912 (along with numerous other components, not shown). The Secure Memory 919 is a set of protected memory regions that may reside in external or on-chip memory, which contains secure firmware, secure CRB memory, and potentially other protected data and register regions. GPIO 908 handles I/O to an external SPI flash memory 914; whereas GPIO 910 handles I/O to an external TPM chip 916. With this configuration, the XPU can closely control access to the TPM chip 916 from the HLOS 904 or any other components of the SoC to provide enhanced slave-side protection.

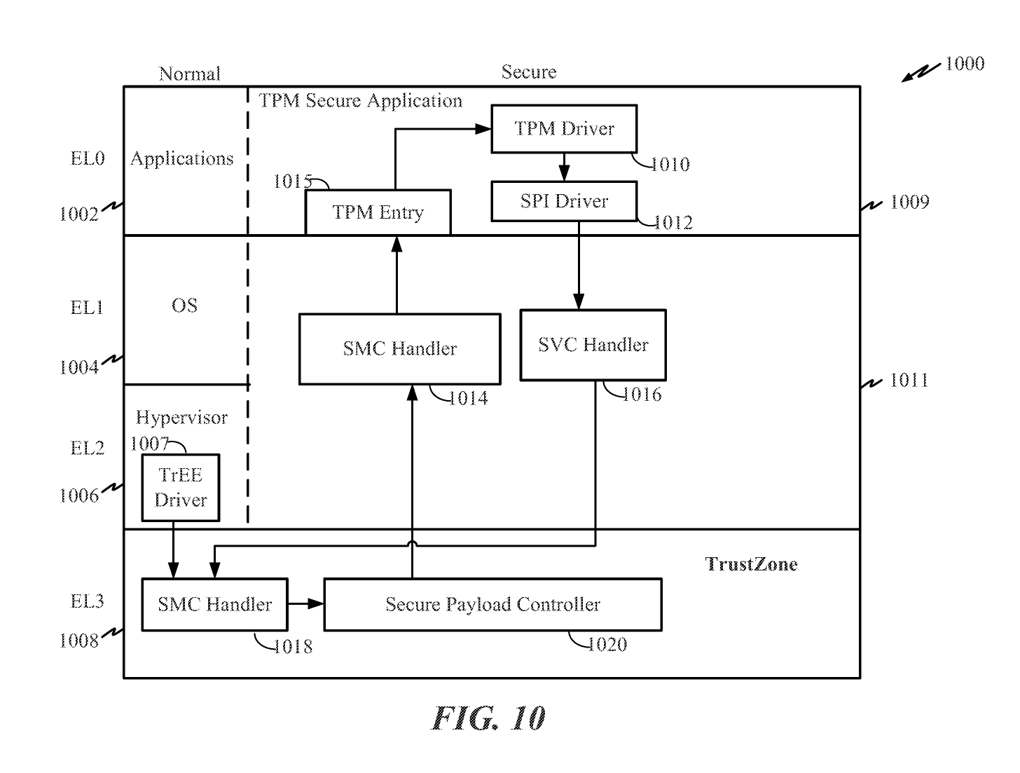

FIG. 10 illustrates aspects of security levels and locality protection. Briefly, within the locality map configuration 1000 of FIG. 10, six security/exception levels are illustrated: EL0 1002, EL1 1004, EL2 1006, EL3 1008, Secure EL0 (SEL0) 1009, and Secure EL1 (SEL1) 1011. Each may have Normal or Secure operations and/or localities. EL0 has the lowest software execution privilege. EL0 generally corresponds to applications or “user space.” EL1 generally corresponds to the HLOS (i.e. the OS “kernel space” and associated functions that are typically described as privileged), EL2 generally corresponds to “hypervisor space” and is generally that level at which the UEFI/BIOS runs. EL3 generally corresponds to secure monitor functions and is traditionally known as TrustZone. Note also that the HLOS can be an OS (running at EL1) or a Hypervisor (running at EL2). For example, Windows OS kernel runs at EL1 while Windows HyperV runs at EL2. UEFI firmware generally boots out of EL2 but can be called from the OS running at EL1.

In the illustrative example of FIG. 10, the secure portion of the TPM driver 1010 is isolated within the Secure EL0, along with the SPI driver 1012, to facilitate implementing TrustZone or other Secure World operations. An SMC handler 1018 and a secure service dispatcher 1020 are provided within EL3. A TrEE driver 1007 within EL2, initiates a “TrEE submit command” and vectors to the SMC handler 1018 within EL3. The SMC handler processes commands and routes the command to the Secure Service Dispatcher 1020, since this command is to be handled by some secure service. The secure service dispatcher 1020 initially vectors certain signals or commands to the SMC handler 1014 of Secure EL1 in conjunction with the submitted command An SMC handler 1014 and an SVC handler 1016 are provided within Secure EL1. The SMC handler 1014 operates, e.g., to “look up” an SMC submitted via a TrEE submit command, determine if the SMC belongs to the TPM service, map the SMC to a local CRB buffer (not shown in FIG. 10) and vector to a TPM delivery entry port 1015. The TPM delivery entry port 1015 routes the command to the TPM driver 1010, which validates the command and outputs its response via the SPI driver 1012 and after the reception and processing of the response, an SVC will be invoked to indicate completion, which will vector to the SVC handler 1016 of Secure EL1. By isolating the TPM in the secure portion of EL0, TrustZone operations are facilitated. The SMC handler 1018 of EL3 also receives the responsive SMC from the SVC handler 1016 of EL1. These details are provided to illustrate one possible implementation, and final implementations may differ.

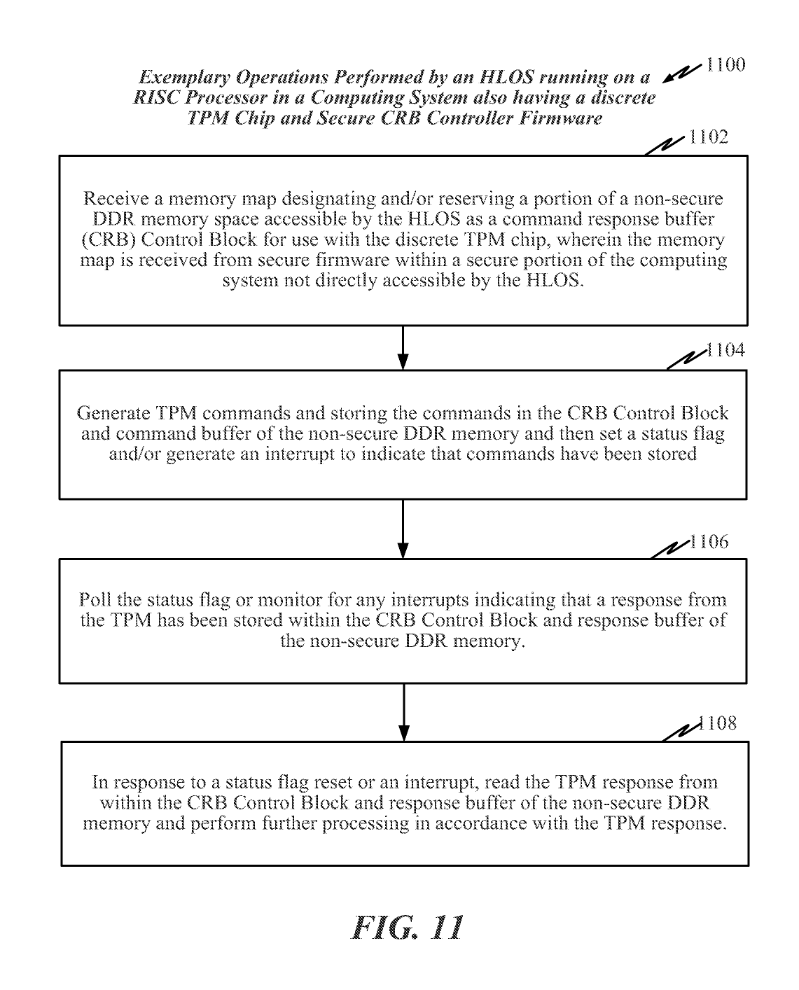

FIG. 11 illustrates and summarizes methods or procedures 1100 that may be performed by a suitably equipped HLOS running on a RISC processor in a computing system that also has a discrete TPM chip and Secure CRB Controller Firmware. Briefly, at 1102, the HLOS receives a memory map designating and/or reserving a portion of a non-secure DDR memory space accessible by the HLOS as a CRB Control Block for use with the discrete TPM chip, wherein the memory map is received from the secure firmware within a secure portion of the computing system not directly accessible by the HLOS. At 1104, the HLOS generates TPM commands and stores the commands in the CRB Control Block and command buffer of the non-secure DDR memory and then sets a status flag and/or generates an interrupt to indicate that commands have been stored in the non-secure CRB memory. At 1106, the HLOS polls the status flag or monitors for any interrupts indicating that a response from the TPM has been stored within the CRB Control Block and response buffer of the non-secure DDR memory. At 1108, in response to a status flag reset or an interrupt, the HLOS reads the TPM response from within the CRB Control Block and response buffer of the non-secure DDR memory and performs further processing in accordance with the TPM response.

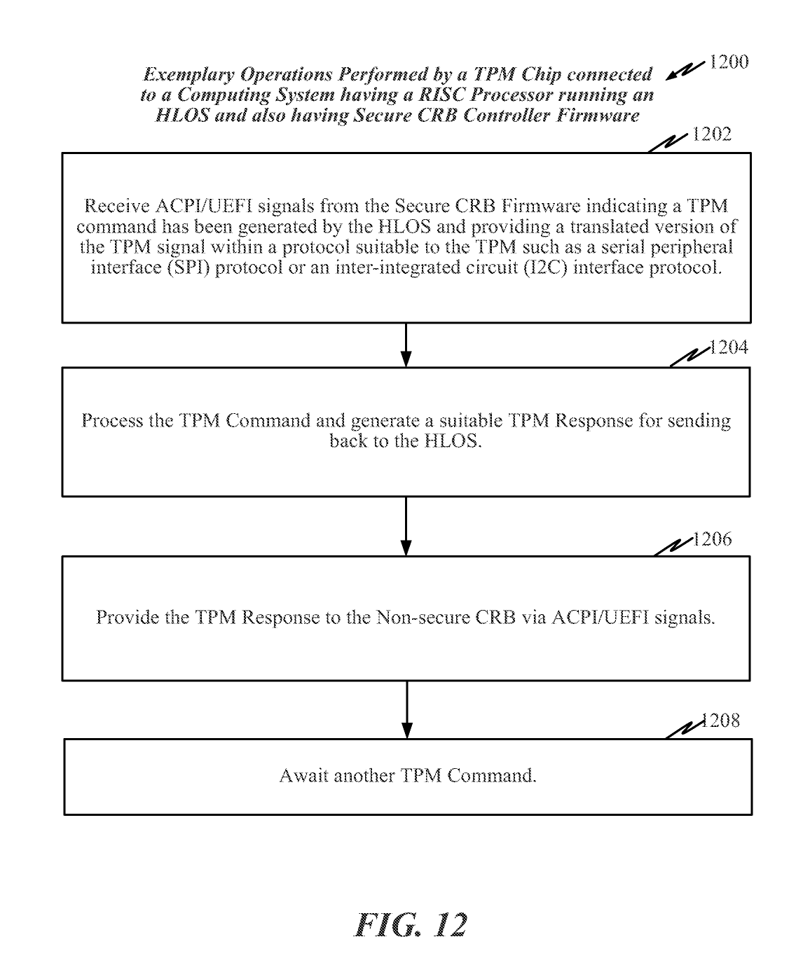

FIG. 12 illustrates and summarizes methods or procedures 1200 that may be performed by a suitably equipped TPM chip connected to a computing system having a RISC processor running an HLOS and also having Secure CRB Controller Firmware. Briefly, at 1202, the TPM chip receives ACPI/UEFI signals (possibly in the form of an interrupt, event, returned execution or some other notification) from the Secure CRB Firmware indicating a TPM command has been generated by the HLOS and providing a translated version of the TPM signal within a protocol suitable to the TPM such as an SPI protocol or an I2C interface protocol. At 1204, the TPM chip processes the TPM Command and generates a suitable TPM Response for sending back to the HLOS. At 1206, the TPM chip provides the TPM Response to the Non-secure CRB via ACPI/UEFI signals. At 1208, the TPM chip waits for another TPM Command.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

Moreover, in the following description and claims the terms “coupled” and “connected,” along with their derivatives, may be used. It should be understood that these terms are not intended as synonyms for each other. Rather, in particular aspects, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An aspect is an implementation or example. Reference in the specification to “an aspect,” “one aspect,” “some aspects,” “various aspects,” or “other aspects” means that a particular feature, structure, or characteristic described in connection with the aspects is included in at least some aspects, but not necessarily all aspects, of the present techniques. The various appearances of “an aspect,” “one aspect,” or “some aspects” are not necessarily all referring to the same aspects. Elements or aspects from an aspect can be combined with elements or aspects of another aspect.

Not all components, features, structures, characteristics, etc. described and illustrated herein need be included in a particular aspect or aspects. If the specification states a component, feature, structure, or characteristic “may,” “might,” “can” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In each figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be noted that, although some aspects have been described in reference to particular implementations, other implementations are possible according to some aspects. Additionally, the arrangement and/or order of circuit elements or other features illustrated in the drawings and/or described herein need not be arranged as illustrated and described. Many other arrangements are possible according to some aspects.

What is claimed is:

1. A method for use in a computing system having a processor equipped to run an operating system (OS) and having a trusted execution environment, comprising:
designating a portion of a memory space accessible by the OS as a command response buffer (CRB) for use with the trusted execution environment; and
relaying messages between the processor and the trusted execution environment using the CRB of the memory space.

2. The method of claim 1, wherein the trusted execution environment includes a trusted platform module (TPM).

3. The method of claim 1, wherein the portion of memory space is designated as a secure CRB by a secure component within a secure portion of the computing system not directly accessible by the OS.

4. The method of claim 3, wherein the secure component comprises a firmware shim.

5. The method of claim 3, wherein the computing system further comprises a portion of non-secure memory designated for use as a non-secure CRB and accessible by the OS.

6. The method of claim 5, wherein relaying messages using the secure component between the processor and the trusted execution environment comprises:
copying commands written by the OS into the non-secure CRB from the non-secure CRB into the secure CRB; and
translating the commands to conform to a particular protocol associated with the trusted execution environment and providing access by the trusted execution environment to the translated commands.

7. The method of claim 6, wherein relaying messages between the processor and the trusted execution environment using the secure component further comprises:
translating command responses received from the trusted execution environment within the secure CRB to conform to a particular protocol associated with the OS of the processor; and
copying the translated responses into the non-secure CRB for access by the OS of the processor.

8. The method of claim 6, wherein the particular protocol associated with the trusted execution environment includes one or more of a serial peripheral interface (SPI), an inter-integrated circuit (I2C) interface and a firmware-based interface.

9. The method of claim 6, wherein a status flag or an interrupt is generated to indicate when commands or responses have been written to the non-secure CRB.

10. The method of claim 3, further comprising using the secure component to control a locality with which a particular component of software running within the OS of the processor can access registers of the memory space based on one or more software privileges.

11. The method of claim 3, wherein the secure component includes a secure CRB memory, a secure command buffer and a secure response buffer.

12. The method of claim 1, wherein the processor is a reduced instruction set computing (RISC) processor.

13. The method of claim 1, wherein a hardware based access control mechanism is equipped to provide slave-side protection to the trusted execution environment.

14. A device comprising:
a processor configured to
designate a portion of a memory space accessible by an operating system (OS) as a command response buffer (CRB); and
relay messages between the processor and a trusted execution environment using the CRB of the memory space.

15. The device of claim 14, wherein the trusted execution environment includes a trusted platform module (TPM).

16. The device of claim 14, wherein the portion of memory space is designated as a secure CRB by a secure component within a secure portion of the computing system not directly accessible by the OS.

17. The device of claim 16, wherein the secure component comprises a firmware shim.

18. The device of claim 16, wherein the computing system further comprises a portion of non-secure memory designated for use as a non-secure CRB and accessible by the OS.

19. The device of claim 18, wherein the secure component is configured to relay messages between the processor and the trusted execution environment by:
copying commands written by the OS into the non-secure CRB from the non-secure CRB into the secure CRB; and
translating the commands to conform to a particular protocol associated with the trusted execution environment and providing access by the trusted execution environment to the translated commands.

20. The device of claim 19, wherein the secure component is configured to relay messages between the processor and the trusted execution environment by:
translating command responses received from the trusted execution environment within the secure CRB to conform to a particular protocol associated with the OS of the processor; and
copying the translated responses into the non-secure CRB for access by the OS of the processor.

21. The device of claim 19, wherein the particular protocol associated with the trusted execution environment includes one or more of a serial peripheral interface (SPI), an inter-integrated circuit (I2C) interface and a firmware-based interface.

22. The device of claim 19, wherein a status flag or an interrupt is generated to indicate when commands or responses have been written to the non-secure CRB.

23. The device of claim 16, wherein the secure component is further configured to control a locality with which a particular component of software running within the OS of the processor can access registers of the memory space based on one or more software privileges.

24. The device of claim 14, wherein the secure component includes a secure CRB memory, a secure command buffer and a secure response buffer.

25. The device of claim 14, wherein the hardware processor is a reduced instruction set computing (RISC) processor.

26. A device for use in a computing system having a processor equipped to run an operating system (OS) and having a trusted execution environment, comprising:
means for designating a portion of a memory space accessible by the OS as a command response buffer (CRB) for use with the trusted execution environment; and
means for relaying messages between the processor and the trusted execution environment using the firmware and the CRB of the memory space.

27. The device of claim 26, wherein the means for designating a portion of a memory space comprises secure firmware within a secure portion of the computing system that is not directly accessible by the OS.

28. The device of claim 26, wherein the processor is a reduced instruction set computing (RISC) processor.

29. A non-transitory machine-readable storage medium for use with a computing system equipped to run an operating system (OS) and having a trusted execution environment, the machine-readable storage medium having one or more instructions which when executed by at least one processing circuit of the computing system causes the at least one processing circuit to:
designate a portion of a memory space accessible by the OS as a command response buffer (CRB) for use with the trusted execution environment; and
relay messages between the processor and the trusted execution environment using the CRB of the memory space.

30. The non-transitory machine-readable storage medium of claim 29, wherein the computing system includes a reduced instruction set computing (RISC) processor.
